(19) United States
(12) Patent Application Publication
(10) Pub. No.: US 2025/0201219 A1
(43) Pub. Date: Jun. 19, 2025

(54) DATA TRANSMITTING DEVICE, DATA RECEIVING DEVICE, DATA TRANSMITTING METHOD, DATA RECEIVING METHOD, EFFECT DEVICE, TERMINAL, MUSICAL INSTRUMENT, AND NON-TRANSITORY COMPUTER-READABLE STORAGE MEDIUM

(71) Applicant: YAMAHA CORPORATION, Hamamatsu-shi (JP)

(72) Inventor: Koichi ISHIZAKI, Hamamatsu-shi (JP)

(21) Appl. No.: 18/961,942

(22) Filed: Nov. 27, 2024

(30) Foreign Application Priority Data
Dec. 14, 2023 (JP) 2023-211550

(51) Int. Cl. G10H 1/00; G10D 3/02

(52) U.S. Cl. CPC G10H 1/0083; G10D 3/02; G10H 1/0008; G10H 1/0091; G10H 2210/155; G10H 2240/321

(57) ABSTRACT

A data transmitting device according to an embodiment comprises a memory storing instructions, and a processor configured to implement the instructions to cause the data transmitting device to: acquire first sound data and second sound data; and transmit the first sound data, the second sound data, and first delimited sound data defining a delimited position between the first sound data and the second sound data as first streaming data to an external device, the first delimited sound data defining a delimited position between the first sound data and the second sound data.

### CROSS-REFERENCE TO RELATED APPLICATIONS

This application claims the benefit of priority to Japanese Patent Application No. 2023-211550, filed on Dec. 14, 2023, the entire contents of which are incorporated herein by reference.

### FIELD

The present disclosure relates to a technique for transmitting and receiving data.

### BACKGROUND

In musical instruments, various contrivances have been made for the generation of sounds. For example, a musical instrument is known in which a sound is produced by vibrating a soundboard by a vibration exciter. A drive signal based on predetermined audio data is supplied to the vibration exciter, and the vibration exciter is driven by the drive signal. The vibration of the vibration exciter is transmitted to the soundboard of the musical instrument, and a sound based on a drive signal is emitted from the musical instrument.

Loop reproduction is performed in which a predetermined musical piece is repeatedly reproduced in a musical instrument by supplying a drive signal of such a vibration exciter. Sound data used for loop reproduction is stored in a storage device provided in the musical instrument. For example, WO 2019/049383 discloses that sound data is stored in a storage device provided in an electronic musical instrument.

### SUMMARY

According to an embodiment of the present disclosure, a data transmitting device is provided comprising a memory storing instructions, and a processor configured to implement the instructions to cause the data transmitting device to: acquire first sound data and second sound data; and transmit the first sound data, the second sound data, and first delimited sound data as first streaming data to an external device, the first delimited sound data defining a delimited position between the first sound data and the second sound data.

According to an embodiment of the present disclosure, a data receiving device is provided comprising a memory storing instructions, and a processor configured to implement the instructions to cause the data receiving device to: receive streaming data including first sound data, second sound data, and delimited sound data defining a delimited position between the first sound data and the second sound data; and extract the first sound data and the second sound data respectively from the streaming data based on the delimited sound data.

According to an embodiment of the present disclosure, an effect device is provided comprising the data receiving device described above, and a processing device configured to generate sound data for loop reproduction based on the first sound data.

According to an embodiment of the present disclosure, a terminal is provided comprising the data receiving device described above, and a memory storing the extracted first sound data and the extracted second sound data in a first storage area and a second storage area, respectively, of the memory.

According to an embodiment of the present disclosure, a musical instrument is provided comprising a soundboard, a vibration exciter attached to the soundboard, and the effect device described above. The vibration exciter is configured to vibrate the soundboard based on the sound data for loop reproduction.

According to an embodiment of the present disclosure, a data transmitting method is provided comprising acquiring first sound data and second sound data, and transmitting the first sound data, the second sound data, and first delimited sound data as streaming data to an external device, the first delimited sound data defining a delimited position between the first sound data and the second sound data.

According to an embodiment of the present disclosure, a data receiving method is provided comprising receiving streaming data including first sound data, second sound data, and delimited sound data defining a delimited position between the first sound data and the second sound data, and extracting the first sound data and the second sound data respectively from the streaming data based on the delimited sound data.

According to an embodiment of the present disclosure, a non-transitory computer-readable storage medium is provided storing a program causing a computer to implement the data transmitting method or the data receiving method described above.

### BRIEF DESCRIPTION OF DRAWINGS

FIG. 1 is a diagram showing a data communication system according to an embodiment of the present disclosure.

FIG. 2 is a side view of a guitar body shown in FIG. 1.

FIG. 3 is a plan view of an inner surface of a back of a body of the guitar body shown in FIG. 1 as viewed from a direction perpendicular to the inner surface.

FIG. 4 is a block diagram showing an example of a configuration of a control device according to an embodiment of the present disclosure.

FIG. 5 is a flowchart for explaining an example of a sound data transmission process according to an embodiment of the present disclosure.

FIG. 6 is a diagram showing an example of streaming data according to an embodiment of the present disclosure.

FIG. 7 is a flowchart for explaining an example of a sound data receiving process according to an embodiment of the present disclosure.

FIG. 8 is a block diagram showing an example of a configuration of a storage part according to an embodiment of the present disclosure.

FIG. 9 is a diagram showing another example of streaming data according to an embodiment of the present disclosure.

FIG. 10 is a diagram showing another example of streaming data according to an embodiment of the present disclosure.

FIG. 11 is a diagram showing another example of streaming data according to an embodiment of the present disclosure.

FIG. 12 is a diagram showing another example of streaming data according to an embodiment of the present disclosure.

FIG. 13 is a diagram showing another example of streaming data according to an embodiment of the present disclosure.

FIG. 14 is a diagram showing another example of streaming data according to an embodiment of the present disclosure.

### DESCRIPTION OF EMBODIMENTS

As stored sound data increases, the capacity of a storage device storing the sound data is squeezed. Therefore, it is considered that sound data to be stored for loop reproduction is transferred to an external storage device and stored. When sound data is transferred between a musical instrument and an external device by wireless communication, a transfer rate is low, which may cause a problem that a large amount of time is required to transfer the sound data.

According to the present disclosure, it is possible to transfer audio data from an external device in a shorter time than before.

Hereinafter, an embodiment of the present disclosure will be described in detail with reference to the drawings. The following embodiments are examples, and the present disclosure should not be construed as being limited to these embodiments. In the drawings referred to in the present embodiment, the same or similar parts are denoted by the same reference signs or similar reference signs (only denoted by A, B, or the like after the numerals), and repeated description thereof may be omitted. In the drawings, dimensional ratios may be different from actual ratios, or a part of the configuration may be omitted from the drawings for clarity of explanation.

### [Data Communication System]

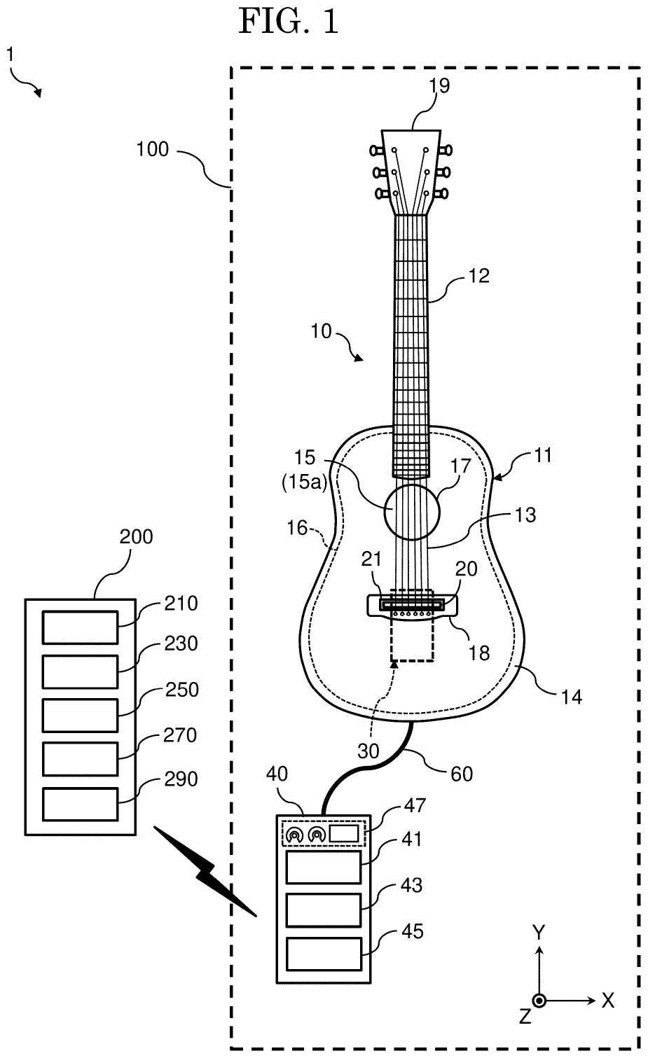

FIG. 1 shows a data communication system 1 according to an embodiment of the present disclosure. The data communication system 1 includes a musical instrument 100 and a terminal 200. The musical instrument 100 and the terminal 200 are capable of wireless communication with each other. The wireless communication between the musical instrument 100 and the terminal 200 is one-to-one short-range wireless communication, and is realized by, for example, Bluetooth™.

### [Structure of Musical Instrument]

The musical instrument 100 includes a guitar body 10, a vibration exciter 30, and an effect device 40. In the present embodiment, the guitar body 10 is an electric acoustic guitar. The vibration exciter 30 is attached to the guitar body 10. The effect device 40 can be connected to the guitar body 10 by a cable 60.

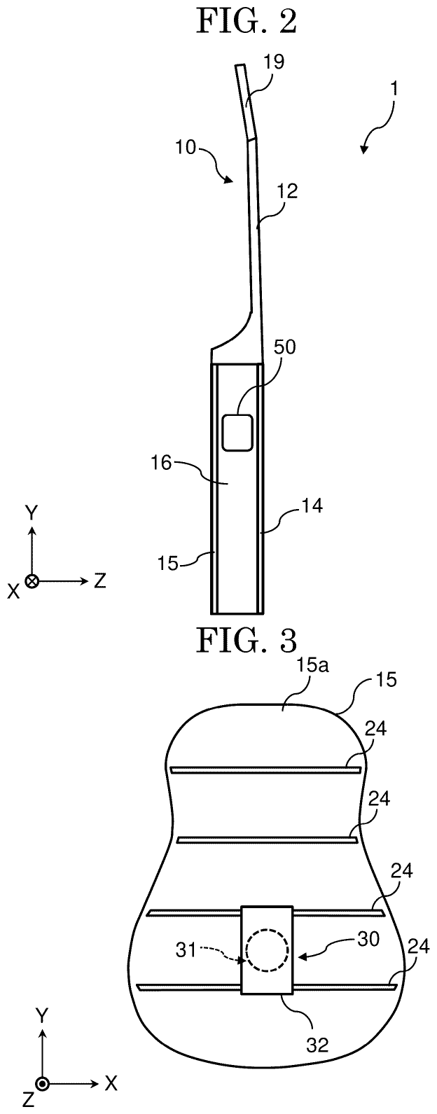

The musical instrument 100 will be described with reference to FIG. 1 to FIG. 3. FIG. 2 is a side view showing the guitar body 10 shown in FIG. 1. FIG. 3 is a plan view of an inner surface of a back 15 of a body 11 of the guitar body 10 shown in FIG. 1 as viewed from a direction perpendicular to the inner surface.

### [Configuration of Guitar Body]

The guitar body 10 includes the body 11, a neck 12, and a string 13. The body 11 is formed in a box shape having a cavity therein. The body 11 includes a front 14, the back 15, and a side 16. The front 14 and the back 15 are flat plates having the same shape. The front 14 and the back 15 are spaced apart from each other in a plate thickness direction. The side 16 extends from a peripheral edge of the back 15 to a peripheral edge of the front 14. The front 14, the back 15, and the side 16 constitute the body 11 having the cavity therein. In the following description, a direction in which the front 14 and the back 15 are arranged (Z-axis direction) may be referred to as an up-down direction.

The front 14 is formed with a sound hole 17 that penetrates in a thickness direction thereof. The sound hole 17 connects the cavity of the body 11 to the space outside the body 11. An outer surface of the front 14 is provided with a bridge 18 for fastening a first end of the string 13 in the longitudinal direction.

A control device 50 is disposed on the side 16. Here, although the control device 50 is disposed on the side 16, the position where the control device 50 is disposed is not limited to the side 16. The control device 50 will be described later. Although not shown, the side 16 may be provided with a terminal part to which a connector of the cable 60 is connected.

The neck 12 extends from the body 11 in a direction substantially orthogonal to the up-down direction (Z-axis direction). At a tip of the neck 12, a head 19 for winding up a second end side in the longitudinal direction of the string 13 is provided. In the following description, the direction orthogonal to the up-down direction and in which the neck 12 mainly extends (Y-axis direction) may be referred to as a front-rear direction. Further, a direction orthogonal to the up-down direction and the front-rear direction may be referred to as a left-right direction (X-axis direction).

The string 13 is stretched over the body 11 and the neck 12 in the front-rear direction. Specifically, the first end of the string 13 is fastened to the bridge 18 of the body 11, and the second end side of the string 13 is wound at the head 19. Thus, the string 13 is stretched between the bridge 18 and the head 19. The string 13 vibrates by a performance operation of a user.

A vibration transmitting part 20 (saddle) is provided between the string 13 and the outer surface of the front 14. In the guitar body 10, the vibration of the string 13 is transmitted to the front 14 via the vibration transmitting part 20, so that the front 14 vibrates, and the back 15 and the side 16 also vibrate. As a result, the air in the body 11 (cavity) resonates, and the sound is radiated to the outside of the body 11.

A pickup 21 detects the vibration of the string 13 and outputs sound data corresponding to the vibration of the string 13. In FIG. 1, the pickup 21 is disposed between the bridge 18 and the vibration transmitting part 20 so as not to hinder the vibration of the front 14 caused by the vibration of the string 13. However, the position at which the pickup 21 is disposed is not limited thereto. For example, the pickup 21 may be disposed on a surface of the front 14 facing the back 15. Sound data output from the pickup 21 is supplied to the control device 50. The sound data is audio data (waveform data).

In addition, the guitar body 10 may include a communication part (not shown). The guitar body 10 can transmit and receive signals to and from an external device via the communication part. In the case where the control device 50 is outside the guitar body 10, the guitar body 10 transmits and receives signals to and from the control device 50 via the communication part.

The control device 50 outputs a drive signal to the vibration exciter 30. The drive signal is generated based on sound data for loop reproduction supplied from the effect device 40 described later. Further, the control device 50 outputs the sound data supplied from the pickup 21 to the effect device 40 in accordance with an operation signal output from an operation part 47 of the effect device 40 described later. Here, the sound data supplied from the pickup 21 may be sound data for each loop reproduction unit based on the operation signal, or may be a series of sound data from the start to the end of the performance.

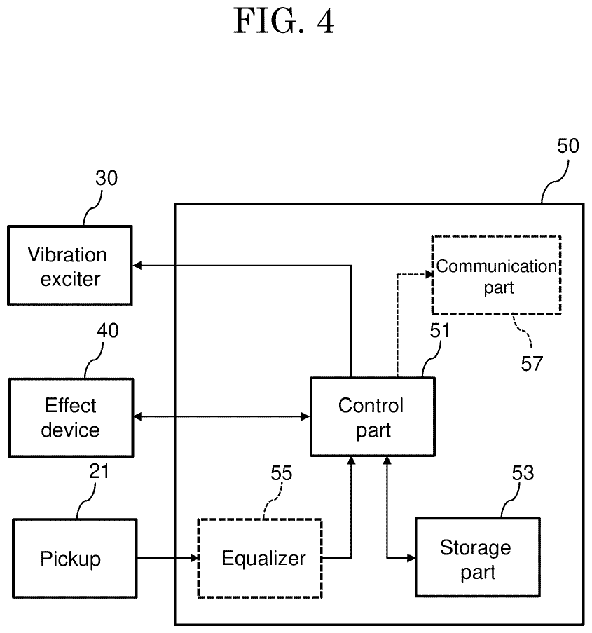

FIG. 4 is a block diagram showing an example of a configuration of the control device 50. The control device 50 includes a control part 51 and a storage part 53. The control device 50 may include an equalizer 55 and a communication part 57. The control device 50 is connected to a main body 31 of the vibration exciter 30 by wire or wirelessly. Here, the control device 50 is attached to the body 11 of the guitar body 10. However, the control device 50 may be an external device capable of communicating with the guitar body 10. In this case, the control device 50 communicates with the guitar body 10 by wire or wirelessly via the communication part 57.

The control part 51 includes an arithmetic processor such as a CPU and a storage device such as a RAM, a ROM, or the like. The control part 51 implements various functions by executing a control program stored in the storage part 53 by the CPU. The storage part 53 is a storage device such as a nonvolatile memory. The storage part 53 stores a control program executed by the control part 51. Further, the storage part 53 stores information necessary for the control part 51 to execute processing. The control part 51 implements various functions by executing the control program.

In the case where the control device 50 includes the equalizer 55, the sound data output from the pickup 21 is supplied to the control part 51 after frequency characteristics are adjusted by the equalizer 55. In the case where the control device 50 does not include the equalizer 55, the sound data is directly supplied to the control part 51. The control part 51 supplies the sound data output from the pickup 21 to the effect device 40 in accordance with the operation signal output from the operation part 47 of the effect device 40 described later. Alternatively, the control part 51 generates the drive signal based on the sound data for loop reproduction supplied from the effect device 40 in response to the operation signal, and supplies the drive signal to the vibration exciter 30.

As shown in FIG. 3, four ribs 24 are attached to an inner surface 15a of the back 15. Each of the ribs 24 is fixed at a predetermined position by bonding or the like to the inner surface 15a. A shape, a number, a position, and the like of the rib 24 shown in FIG. 2 are examples, and the position and the like may be changed as appropriate depending on a purpose of increasing rigidity of the back 15, a purpose of adjusting a tone of the guitar 1, and the like.

### [Configuration of Vibration Exciter]

The vibration exciter 30 includes a vibration exciter main body 31 (hereinafter referred to as a main body 31) and a support part 32. The main body 31 is connected to the control device 50. The main body 31 vibrates the back 15 (soundboard) of the body 11 in accordance with the drive signal. The main body 31 may be connected to the control device 50 by wire, or may be wirelessly connected to the control device 50 so that a wireless unit (not shown) provided in the main body 31 receives a signal from the control device 50. The support part 32 supports the main body 31 and is fixed to two rods 24 adjacent to each other in the front-rear direction on the inner surface 15a of the back 15. The main body 31 may be, for example, a voice coil type actuator. In addition, although an example in which the back 15 is vibrated has been shown in the present embodiment, the location to be vibrated is not limited to the back 15. For example, the main body 31 of the vibration exciter 30 may vibrate the front 14 or both the back 15 and the front 14. Alternatively, the main body 31 of the vibration exciter 30 may vibrate the side 16 and may vibrate the side 16, the front 14, and/or the back 15.

### [Configuration of Effect Device]

Next, referring back to FIG. 1, the effect device 40 will be described. The effect device 40 is a device that implements a loop function. In addition to the loop function, the effect device 40 may be a multi-effector such as a stomp pedal that can impart effects such as limiter, chorus, delay, reverb, and the like to the sound data. The effect device 40 is connected to the guitar body 10 via the cable 60. The effect device 40 includes a control part 41, a storage part 43, a communication part 45, and the operation part 47. Further, although not shown, the effect device 40 has a terminal part to which the connector of the cable 60 is connected.

The control part 41 includes an arithmetic processor such as a CPU and a storage device such as a RAM or a ROM. The control part 41 executes a control program stored in the storage part 43 by the CPU to realize various functions including a loop function. The loop function includes a function of recording sound data (recording function) based on a performance operation, a function of generating sound data for loop reproduction, a function of transmitting sound data, and a function of receiving sound data. The respective functions realized by the control part 41 will be described later.

The storage part 43 is a storage device such as a nonvolatile memory. The storage part 43 stores the control program executed by the control part 41. Further, the storage part 43 stores information necessary for the control part 41 to execute processing. The storage part 43 has a plurality of storage areas. The storage part 43 stores sound data supplied from the control device 50 described above or the terminal 200 described below. The storage part 43 stores the supplied sound data as the sound data for each loop reproduction unit in a different storage area for each loop reproduction unit.

The communication part 45 performs short-range wireless communication with the terminal 200 and transmits streaming data including sound data to the terminal 200. The operation part 47 includes one or more setting operators for controlling various functions realized by the control part 41. The setting operators include an operation button, a touch sensor, a slider, and the like. In addition, in the case where the effect device 40 includes a display part (not shown) that displays an image, the operation part 47 may be provided as an operator image displayed on the display. An operation signal is output from the operation part 47 in response to an operation by the user. The operation signal includes information that controls processing related to the loop function. For example, the operation signal includes processing designation information for designating a desired process among processes related to a loop including a recording process and a loop reproduction process, timing designation information for specifying a start or end timing of a process related to the loop, sound data designation information for designating sound data used for a process related to the loop, and the like. Further, the operation part 47 may include a plurality of operators for setting effects, such as a limiter, chorus, delay, or reverb, to be added to sound data for loop reproduction, which will be described later. The user sets a parameter value of each effector by operating the operator. The operation signal is output to the control part 41.

The control part 41 realizes a recording function based on the processing designation information and the timing designation information. Specifically, when the processing designation information indicates the recording processing, the control part 41 acquires the sound data based on the performance operation to the guitar body 10 from the control device 50 as the sound data for each loop reproduction unit, and stores the sound data in each storage area of the storage part 43. The sound data acquired from the control device 50 is based on the timing designation information. In this case, the timing designation information indicates the start and end timings of recording.

Further, the control part 41 realizes a function of generating sound data for loop reproduction based on the processing designation information, the timing designation information, and the sound data designation information. Specifically, in the case where the processing designation information indicates the loop reproduction process, the control part 41 acquires predetermined sound data from the storage part 43 based on the sound data designation information. Further, the control part 41 generates sound data for loop reproduction based on predetermined sound data, and supplies the generated sound data for loop reproduction to the control device 50. The sound data for loop reproduction is based on timing designation information. In this case, the timing designation information indicates the start and end timings of loop reproduction. As described above, the control part 41 functions as a processing device that generates sound data for loop reproduction based on the processing designation information. Further functions of the control part 41 will be described later.

### [Configuration of Terminal]

Next, the terminal 200 will be described. The terminal 200 is, for example, an electronic device capable of short-range wireless communication with the effect device 40 such as a smart phone, a laptop PC, or a desktop PC, and can communicate with the effect device 40 using, for example, Bluetooth™. The terminal 200 includes a control part 210, a storage part 230, a communication part 250, an operation part 270, and a display part 290.

The control part 210 includes an arithmetic processor such as a CPU and a storage device such as a RAM or a ROM. The control part 210 executes a control program stored in the storage part 230 by the CPU to realize various functions including a function of transmitting sound data and a function of receiving sound data. Further, the control part 210 provides a user interface for receiving user input for the desired process on the display part 290 described later.

The storage part 230 is a storage device such as a nonvolatile memory. The storage part 230 stores a control program executed by the control part 210. The storage part 230 stores information necessary for the control part 210 to execute processing. The storage part 230 has a plurality of storage areas. The storage part 230 stores sound data supplied from the effect device 40 described above or an external device. When the supplied sound data is for each loop reproduction unit, the storage part 230 stores the sound data in a different storage area for each loop reproduction unit. Functions of the storage part 230 may be realized by an external device that can communicate with the communication part 250.

The communication part 250 can perform short-range wireless communication with the effect device 40. The communication part 250 can also communicate with an external device via a network. The operation part 270 includes one or more setting operators for controlling various functions realized by the control part 210. The setting operators include an operation button, a touch sensor, a slider, and the like. At least a part of the operation part 270 is provided as an operator image on a user interface displayed on the display part 290. An instruction signal is output from the operation part 270 in response to an operation by the user. The instruction signal includes a sound data receiving instruction, a sound data transmission instruction, a sound data specifying instruction to specify sound data to be received/transmitted, a storage destination designation instruction to designate a storage destination of sound data, a communication designation instruction to designate a partner to perform short-range wireless communication, and the like. The instruction signal is output to the control part 210.

The display part 290 displays an image based on the control of the control part 210. The display part 290 is provided with a user interface for the user to input the desired process. The user interface includes at least a part of the operation part 270 described above as an operator image.

In response to the sound data receiving instruction or the sound data transmission instruction included in the instruction signal from the operation part 270, the control part 210 of the terminal 200 and the control part 41 of the effect device 40 function as a transmitting device of sound data or a receiving device of sound data, respectively. Hereinafter, the sound data transmission and the receiving functions of the control part 210 of the terminal 200 and the control part 41 of the effect device 40 will be described.

### [Sound Data Transmission and Receiving Functions]

In the case where the sound data receiving instruction is included in the instruction signal, the control part 210 of the terminal 200 realizes the function of receiving the sound data, and the control part 41 of the effect device 40 realizes the function of transmitting the sound data. In other words, in the case where the sound data receiving instruction is included in the instruction signal, the control part 210 of the terminal 200 functions as a sound data receiving device, and the control part 41 of the effect device 40 functions as a sound data transmitting device.

In a case where the sound data receiving instruction is included in the instruction signal, the control part 210 identifies a device to be communicated with by the terminal 200 based on the communication designation instruction. In this case, the control part 210 may request a list of sound data stored in each device to all devices capable of communicating with the terminal 200, and acquire the list. The user may refer to the acquired list and determine a device storing desired sound data as a device to be communicated with by the terminal 200. The user specifies a device to be communicated with by the communication designation instruction. Here, a case where the effect device 40 is identified as a device to be communicated with by the terminal 200 will be described. The control part 210 performs short-range wireless communication with the effect device 40 based on the communication designation instruction.

The control part 210 supplies a sound data specifying instruction to the control part 41 of the terminal 40. Here, the sound data specifying instruction indicates sound data that the user desires to receive by the terminal 200. The control part 41 realizes a function of transmitting sound data based on the received sound data specifying instruction.

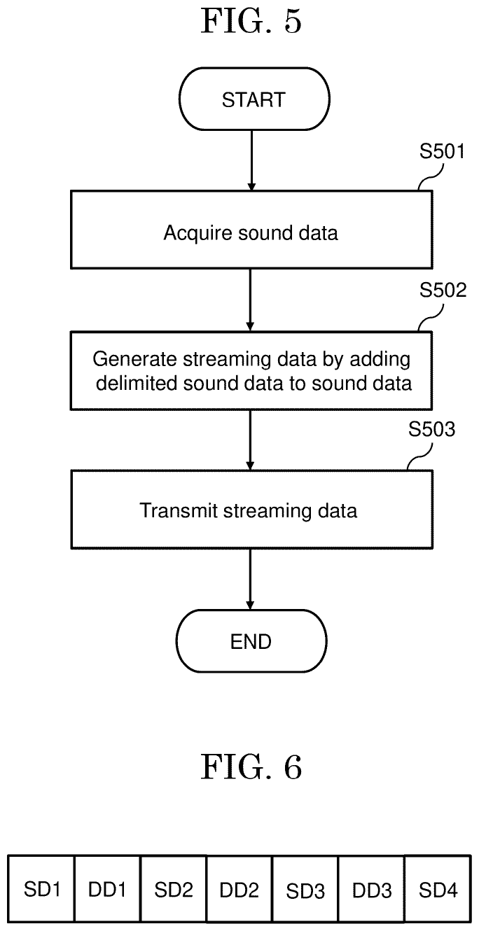

FIG. 5 is a flowchart for explaining an example of a sound data transmission process executed by the control part 41. The control part 41 acquires predetermined sound data from the storage part 43 based on the sound data specifying instruction (S501).

Next, the control part 41 generates streaming data by adding the delimited sound data defining the delimited acquired sound data to the sound data (S502). The delimited sound data is audio data that defines delimited sound data for each loop reproduction unit. The delimited sound data is arranged immediately before or immediately after the sound data of a predetermined loop reproduction unit. That is, the delimited sound data arranged between sound data of a predetermined loop reproduction unit and sound data of the next loop reproduction unit can be said to indicate the end of the sound data of the predetermined loop reproduction unit, and can also be said to indicate the start of the sound data of the next loop reproduction unit.

FIG. 6 is a diagram showing an example of streaming data generated by the control part 41. Here, a case where predetermined four pieces of sound data are specified by the sound data specifying instruction will be described. The streaming data shown in FIG. 6 includes at least first sound data SD1 corresponding to the first loop reproduction unit, second sound data SD2 corresponding to the second loop reproduction unit, third sound data SD3 corresponding to the third loop reproduction unit, fourth sound data SD4 corresponding to the fourth loop reproduction unit, first delimited sound data DD1 defining a separation between the first sound data SD1 and the second sound data SD2, second delimited sound data DD2 defining a separation between the second sound data SD2 and the third sound data SD3, and third delimited sound data DD3 defining a separation between the third sound data SD3 and the fourth sound data SD4.

The first delimited sound data DD1 is arranged between the first sound data SD1 and the second sound data SD2. The first delimited sound data DD1 indicates the end of the first sound data SD1 or the start of the second sound data SD2. The second delimited sound data DD2 is arranged between the second sound data SD2 and the third sound data SD3. The second delimited sound data DD2 indicates the end of the second sound data SD2 or the start of the third sound data SD3. The third delimited sound data DD3 is arranged between the third sound data SD3 and the fourth sound data SD4. The third delimited sound data DD3 indicates the end of the third sound data SD3 or the start of the fourth sound data SD4. Although not shown in the figure, the delimited sound data indicating the start of the first sound data SD1 may be further arranged prior to the first sound data SD1. Further, delimited sound data indicating the end of the fourth sound data SD4 may be further arranged.

The streaming data shown in FIG. 6 is monaural data including sound data of four loop reproduction units. However, the streaming data may be stereo data.

Next, the control part 41 transmits the generated streaming data to the terminal 200 (S503), and ends the process. The streaming data is transmitted to the terminal 200 by short-range wireless communication via the communication part 45.

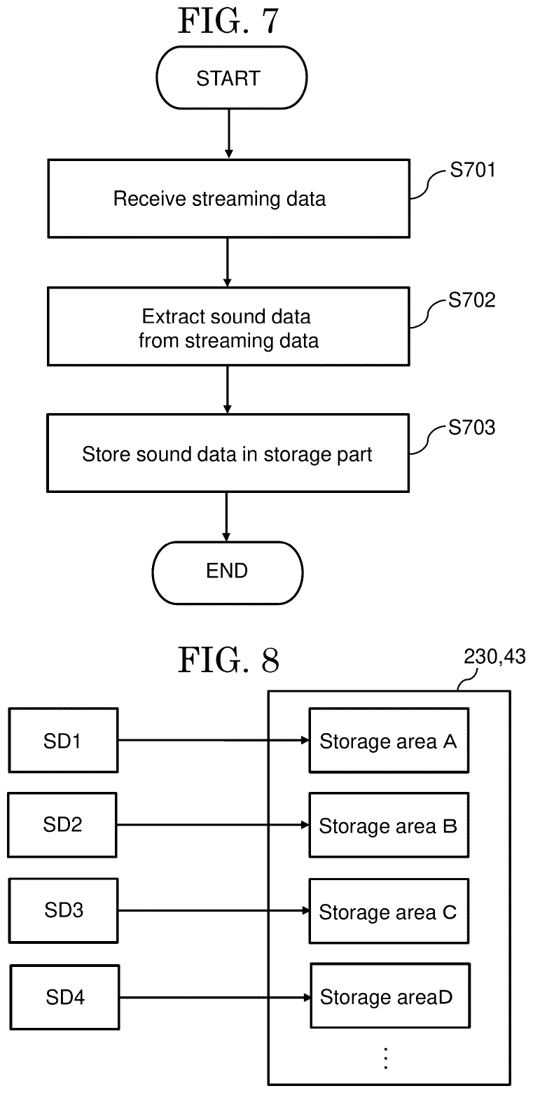

On the other hand, the control part 210 of the terminal 200 realizes a sound data receiving function of receiving the streaming data transmitted from the effect device 40 and extracting the sound data. FIG. 7 is a flow chart for explaining an example of the sound data receiving process executed by the control part 210. The control part 210 receives the streaming data transmitted from the effect device 40 (S701).

Next, the control part 210 extracts the sound data of the loop reproduction unit from the streaming data based on the delimited sound data included in the received streaming data (S702). The control part 210 stores the sound data extracted from the streaming data in different storage areas of the storage part 230, respectively (S703), and ends the process.

FIG. 8 is a block diagram showing an example of a configuration of the storage part 230 of the terminal 200. The storage part 230 has a plurality of storage areas (storage area A, storage area B, storage C, storage area D, . . . ). The storage part 230 stores the sound data extracted from the streaming data by the control part 210. The sound data is stored in different storage areas for each loop reproduction unit. For example, in the case where the streaming data shown in FIG. 6 is received by the control part 210, four pieces of sound data (first sound data SD1, second sound data SD2, third sound data SD3, and fourth sound data SD4) are extracted from the streaming data. Each of the extracted sound data is stored in a different storage area of the storage part 230. For example, as shown in FIG. 8, the first sound data SD1 is stored in the storage area A, the second sound data SD2 is stored in the storage area B, the third sound data SD3 is stored in the storage area C, and the fourth sound data SD4 is stored in the storage area D.

In the above description, in the case where the sound data receiving instruction is included in the instruction signal, the control part 210 of the terminal 200 realizes the function of receiving the sound data, and the control part 41 of the effect device 40 realizes the function of transmitting the sound data. On the other hand, in the case where the sound data transmission instruction is included in the instruction signal, the control part 210 of the terminal 200 realizes the function of transmitting the sound data, and the control part 41 of the effect device 40 realizes the function of receiving the sound data. In other words, in the case where the sound data transmission instruction is included in the instruction signal, the control part 210 of the terminal 200 functions as a transmitting device for the sound data, and the control part 41 of the effect device 40 functions as a receiving device for the sound data.

In the case where the sound data transmission instruction is included in the instruction signal, the control part 210 identifies a device to be communicated with by the terminal 200 based on the storage destination designation instruction specifying the storage destination of the sound data. That is, the control part 210 specifies the device corresponding to the storage destination of the sound data designated by the user as the device to be communicated with by the terminal 200. Here, a case where the effect device 40 is specified as the device to be communicated with by the terminal 200 will be described. The control part 210 performs short-range wireless communication with the effect device 40 based on the storage destination designation instruction.

The control part 210 acquires predetermined sound data from the storage part 230 based on the sound data specifying instruction. Here, the sound data specifying instruction indicates sound data that the user desires to transmit to the effect device 40. The control part 210 realizes a function of transmitting sound data based on the received sound data specifying instruction.

A transmission process of the sound data executed by the control part 210 is the same as the transmission process of the sound data executed by the control part 41 described with reference to FIG. 5. That is, the control part 210 acquires predetermined sound data from the storage part 230 based on the sound data specifying instruction (S501), imparts the delimited sound data defining a separation of the acquired sound data to the sound data to generate streaming data (S502), transmits the generated streaming data to the effect device 40 (S503), and ends the process. The streaming data is transmitted to the effect device 40 by short-range wireless communication via the communication part 250.

On the other hand, the control part 41 of the effect device 40 realizes a sound data receiving function of receiving the streaming data transmitted from the terminal 200 and extracting the sound data. A receiving process of the sound data executed by the control part 41 is the same as the receiving process of the sound data executed by the control part 210 described with reference to FIG. 7. That is, the control part 41 receives the streaming data transmitted from the terminal 200 (S701), extracts the sound data of each loop reproduction unit from the streaming data based on the delimited sound data included in the received streaming data (S702), stores the sound data extracted from the streaming data in different storage areas of the storage part 43, respectively (S703), and ends the process. A configuration of the storage part 43 is the same as the configuration of the storage part 230 of the terminal 200 shown in FIG. 8.

As described above, the control part 41 generates the sound data for loop reproduction based on the operation signal from the operation part 47 in response to the user's operation. That is, in the case where the processing designation information indicates a loop reproduction process, the control part 41 acquires predetermined sound data from the storage part 43 based on the sound data designation information, and generates sound data for loop reproduction based on the predetermined sound data. The sound data for loop reproduction is based on the timing designation information. The control part 41 supplies the generated sound data for loop reproduction to the control device 50. The control device 50 generates a drive signal for driving the vibration exciter 30 based on the supplied sound data for loop reproduction, and supplies the drive signal to the vibration exciter 30.

As described above, in the present embodiment, in the short-range wireless communication between the effect device 40 and the terminal 200, the sound data for each loop reproduction unit is transmitted and received in a streaming format together with the delimited sound data. Therefore, it is possible to transmit and receive sound data between the musical instrument 100 and the terminal 200 in a shorter time than before.

### [Modifications]

The present disclosure is not limited to the embodiments described above, and includes various other modifications. For example, the embodiments described above have been described in detail for the purpose of showing the present disclosure in an easy-to-understand manner, and are not necessarily limited to those having all the described configurations. Further, another configuration may be added to the configuration of one embodiment, a part of the configuration may be deleted, or a part of the configuration may be replaced with another configuration. Some modification examples will be described below.

(1) In the embodiment described above, the control part 41 generates sound data for loop reproduction based on predetermined sound data in accordance with an operation signal. Here, the control part 41 may generate sound data for loop reproduction by mixing a plurality of sound data. For example, the control part 41 may mix the first sound data and the second sound data different from each other, and generate sound data for loop reproduction based on the mixed sound data.

(2) In the embodiment described above, the control part 210 of the terminal 200 transmits and receives the streaming data including the sound data to and from the effect device 40 based on the instruction signal. However, the terminal 200 may acquire predetermined music data from an external device such as an external server or another terminal via the communication part 250 based on an instruction from the user via the operation part 270, and store the acquired music data in the storage part 250. The communication part 250 performs data communication with the external device by wire or wirelessly. A communication method may be network communication. The music data may include accompaniment data, voice data, and the like.

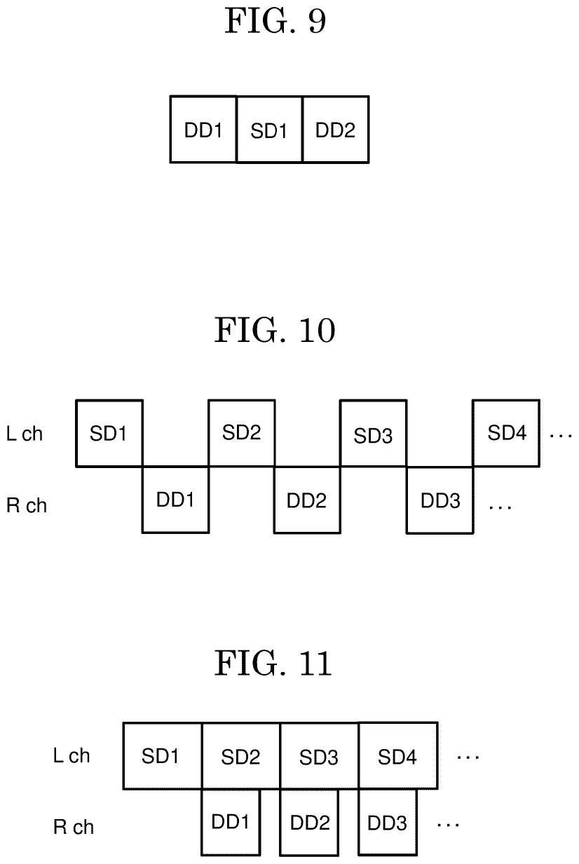

(3) In the embodiment described above, with reference to FIG. 6, it has been described that the control part 41 of the effect device 40 and the control part 210 of the terminal 200 generate the streaming data by adding the delimited sound data that defines the separation of the sound data to the sound data. However, the streaming data generated by the control part 41 and the control part 210 is not limited to the streaming data shown in FIG. 6. FIG. 9 to FIG. 14 are diagrams showing examples of streaming data generated by the control part 41 and the control part 210, respectively.

FIG. 9 is an example of streaming data including sound data of one loop reproduction unit. That is, this is an example of streaming data generated in the case where the terminal 200 acquires or transmits one piece of sound data in response to a sound data specifying instruction. The streaming data includes the first delimited sound data DD1 and the second delimited sound data DD2 that define the separation of the first sound data SD1 corresponding to a first looped reproduction unit. The first delimited sound data DD1 is arranged prior to the first sound data SD1. That is, the first delimited sound data DD1 indicates the start of the first sound data SD1. The second delimited sound data DD2 is arranged after the first sound data SD1 and indicates the end of the first sound data SD1. One of the first delimited sound data DD1 and the first delimited sound data DD2 may be omitted.

The streaming data shown in FIG. 6 and FIG. 9 is monaural data. However, the streaming data may be stereo data as long as stereo-compatible communication is possible between the effect device 40 and the terminal 200.

FIG. 10 is an example of streaming data generated by the control part 41 and the control part 210 and includes sound data of at least four loop reproduction units. That is, this is an example of the streaming data generated when at least four pieces of sound data are acquired or transmitted by the terminal 200 in response to the sound data specifying instruction. The streaming data includes at least four pieces of sound data (first sound data SD1, second sound data SD2, third sound data SD3, and fourth sound data SD4) and at least three pieces of delimited sound data (first delimited sound data DD1, second delimited sound data DD2, and third delimited sound data DD3) defining a separation of the respective sound data.

The streaming data shown in FIG. 10 is stereo data. That is, the sound data and the delimited sound data are transmitted using two channels. For example, the first sound data SD1, the second sound data SD2, the third sound data SD3, and the fourth sound data SD4, which are sound data corresponding to the respective loop reproduction units, are transmitted with a first channel (here, Lch), and the first delimited sound data DD1, the second delimited sound data DD2, and the third delimited sound data DD3 are transmitted with a second channel (here, Rch) which is different from the first channel. The streaming data is transmitted in synchronization with the first channel and the second channel.

FIG. 10 shows that the sound data transmitted with the first channel and the delimited sound data transmitted with the second channel are transmitted so as not to overlap each other. However, the method of transmitting the streaming data is not limited thereto. For example, the streaming data may be transmitted such that each sound data transmitted with the first channel and each delimited sound data transmitted with the second channel overlap each other at least in part.

FIG. 11 is another example of streaming data generated by the control part 41 and the control part 210 and including sound data of at least four loop reproduction units. In the streaming data shown in FIG. 11, similar to FIG. 10, the first sound data SD1, the second sound data SD2, the third sound data SD3, and the fourth sound data SD4 are transmitted with a first channel (here, Lch), and the first delimited sound data DD1, the second delimited sound data DD2, and the third delimited sound data DD3 are transmitted with a second channel (here, Rch). In the streaming data shown in FIG. 11, at least a part of the delimited sound data transmitted with the second channel is transmitted so as to overlap the sound data transmitted with the first channel.

FIG. 10 and FIG. 11 show an example in which the sound data is transmitted with the first channel and the delimited sound data is transmitted with the second channel. However, sound data and delimited sound data may be transmitted with each of the two channels.

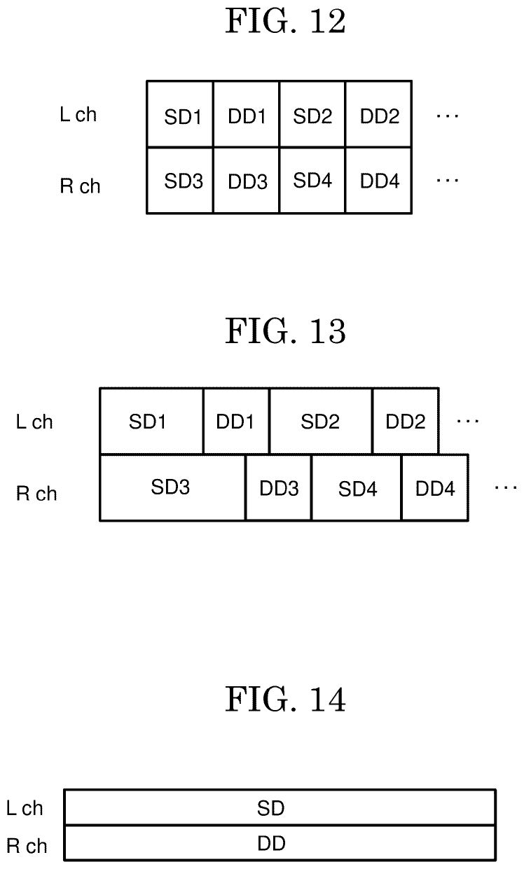

FIG. 12 is yet another example of streaming data including sound data of at least four loop reproduction units. In the streaming data shown in FIG. 12, the first sound data SD1, the second sound data SD2, the first delimited sound data DD1 defining the separation between the first sound data SD1 and the second sound data SD2, and the second delimited sound data DD2 defining the separation between the second sound data SD2 and the subsequent sound data are transmitted with a first channel (here, Lch). On the other hand, the third sound data SD3, the fourth sound data SD4, the third delimited sound data DD3 defining the separation between the third sound data SD3 and the fourth sound data SD4, and the fourth delimited sound data DD4 defining the separation between the fourth sound data SD4 and the subsequent sound data are transmitted with a second channel (here, Rch).

In FIG. 12, in the case where the streaming data includes only the sound data of the four loop reproduction units, that is, the first sound data SD1, the second sound data SD2, the third sound data SD3, and the fourth sound data SD4, the second delimited sound data DD2 and the fourth delimited sound data DD4 may be omitted.

Further, in FIG. 12, the starts and ends of the first sound data SD1 and the third sound data SD3 are aligned, and the starts and ends of the second sound data SD2 and the fourth sound data SD4 are aligned. In other words, in the first channel and the second channel, the first sound data SD1 and the third sound data SD3 overlap each other, the first delimited sound data DD1 and the third delimited sound data DD3 overlap each other, the second sound data SD2 and the fourth sound data SD4 overlap each other, and the second delimited sound data DD2 and the fourth delimited sound data DD4 overlap each other. However, depending on a length of the sound data of each loop reproduction unit, the start and end of the sound data transmitted with the first channel and the second channel may be deviated from each other. In other words, in the first channel and the second channel, positions of the delimited sound data may be misaligned.

FIG. 13 is yet another example of streaming data including sound data of at least four loop reproduction units. In the streaming data shown in FIG. 13, similar to the streaming data shown in FIG. 12, the first sound data SD1, the second sound data SD2, the first delimited sound data DD1, and the second delimited sound data DD2 are transmitted with the first channel, and the third sound data SD3, the fourth sound data SD4, the third delimited sound data DD3, and the fourth delimited sound data DD4 are transmitted with the second channel. However, unlike the streaming data shown in FIG. 12, in the streaming data shown in FIG. 13, the ends of the first sound data SD1 and the end of the third sound data SD3 are not aligned with each other, and the starts and ends of the second sound data SD2 and the end of the fourth sound data SD4 are not aligned with each other. In other words, in the first channel and the second channel, a position of the first delimited sound data DD1 and a position of the third delimited sound data DD3 are not aligned with each other, and a position of the second delimited sound data DD2 and a position of the fourth delimited sound data DD4 are not aligned with each other.

In the streaming data shown in FIG. 6, FIG. 9, and FIG. 13, delimited sound data indicating separations of sound data is inserted between sound data of different loop reproduction units. The delimited sound data indicates an end of the previous sound data or a start of the subsequent sound data. However, the delimited sound data may be time designation data such as a time stamp for designating a loop reproduction unit.

FIG. 14 is an example of streaming data including delimited sound data specifying each loop reproduction unit. As shown in FIG. 14, for example, sound data SD is transmitted with a first channel (here, Lch), and a delimited sound data DD specifying each loop-reproduction unit is transmitted with a second channel. The streaming data shown in FIG. 6 and FIG. 9 to FIG. 13 includes sound data of each loop reproduction unit. In contrast, the sound data SD included in the streaming data shown in FIG. 14 is the music data acquired from an external device by the control part 210 of the terminal 200 described in the modification (2) described above. The delimited sound data DD is time designation data such as a time stamp for specifying each loop reproduction unit in the music data. The time designation data can be set by the user via the operation part 270 of the terminal 200.

(4) In the embodiment described above, the effect device 40 is a device that can be connected to the guitar body 10 by wire. However, the effect device 40 may be incorporated into the guitar main body 10 together with the control device 50 as one unit. In this case, the control part 51 of the control device 50 and the control part 41 of the effect device 40 may be common.

(5) In the embodiment described above, the case has been described in which the musical instrument 100 includes the guitar body 10. However, the main body of the musical instrument 100 is not limited to a guitar. For example, the main body of the musical instrument 100 may be a keyboard musical instrument, such as a piano or a synthesizer, including a key as a performance operator.

(6) In the embodiment described above, the effect device 40 supplies sound data for loop reproduction to the control device 50. However, the effect device 40 may be connected to a speaker and may provide sound data for loop reproduction to the speaker. The speaker to which the sound data for loop reproduction is supplied emits sound based on the sound data for loop reproduction.

What is claimed is:

1. A data transmitting device comprising:
a memory storing instructions; and
a processor configured to implement the instructions to cause the data transmitting device to:
acquire first sound data and second sound data; and
transmit the first sound data, the second sound data, and first delimited sound data as first streaming data to an external device, the first delimited sound data defining a delimited position between the first sound data and the second sound data.

2. The data transmitting device according to claim 1, wherein the first delimited sound data is audio data.

3. The data transmitting device according to claim 1, wherein the first delimited sound data is arranged between the first sound data and the second sound data.

4. The data transmitting device according to claim 1, wherein the first sound data and the second sound data are transmitted by the data transmitting device with a first channel, and the first delimited sound data is transmitted by the data transmitting device with a second channel different from the first channel.

5. The data transmitting device according to claim 1, wherein the processor is configured to implement the instructions to further cause the data transmitting device to:
acquire third sound data and fourth sound data;
transmit the first sound data, the second sound data, and the first delimited sound data as the first streaming data to the external device with a first channel; and
transmit the third sound data, the fourth sound data, and second delimited sound data as second streaming data to the external device with a second channel different from the first channel, the second delimited sound data defining a delimited position between the third sound data and the fourth sound data.

6. The data transmitting device according to claim 1, wherein the processor is configured to implement the instructions to further cause the data transmitting device to:
acquire third sound data and fourth sound data;
transmit the first sound data, the second sound data, the third sound data and the fourth sound data as the first streaming data to the external device with a first channel; and
transmit the first delimited sound data, second delimited sound data, and third delimited sound data as second streaming data to the external device with a second channel different from the first channel, the second delimited sound data defining a delimited position between the second sound data and the third sound data, and the third delimited sound data defining a delimited position between the third sound data and the fourth sound data.

7. A data receiving device comprising:
a memory storing instructions; and
a processor configured to implement the instructions to cause the data receiving device to:
receive streaming data including first sound data, second sound data, and delimited sound data defining a delimited position between the first sound data and the second sound data; and
extract the first sound data and the second sound data respectively from the streaming data based on the delimited sound data.

8. The data receiving device according to claim 7, wherein the first delimited sound data is audio data.

9. An effect device comprising:
the data receiving device according to claim 7; and
a processing device configured to generate sound data for loop reproduction based on the first sound data.

10. The effect device according to claim 9, wherein the processing device is further configured to mix the first sound data and the second sound data to generate the sound data for loop reproduction.

11. A terminal comprising:
the data receiving device according to claim 7; and
a memory storing the extracted first sound data and the extracted second sound data in a first storage area and a second storage area, respectively, of the memory.

12. A musical instrument comprising:
a soundboard;
a vibration exciter attached to the soundboard; and
the effect device according to claim 9,
wherein the vibration exciter is configured to vibrate the soundboard based on the sound data for loop reproduction.

13. A data transmitting method comprising:
acquiring first sound data and second sound data; and
transmitting the first sound data, the second sound data, and first delimited sound data as streaming data to an external device, the first delimited sound data defining a delimited position between the first sound data and the second sound data.

14. The data transmitting method according to claim 13, wherein the first delimited sound data is arranged between the first sound data and the second sound data.

15. The data transmitting method according to claim 13, wherein transmitting the first sound data, the second sound data, and first delimited sound data as the streaming data to the external device comprises transmitting the first sound data and the second sound data with a first channel, and transmitting the first delimited sound data with a second channel different from the first channel.

16. A data receiving method comprising:
receiving streaming data including first sound data, second sound data, and delimited sound data defining a delimited position between the first sound data and the second sound data; and
extracting the first sound data and the second sound data respectively from the streaming data based on the delimited sound data.

17. A non-transitory computer-readable storage medium storing a program causing a computer to implement:
acquiring first sound data and second sound data; and
transmitting the first sound data, the second sound data, and first delimited sound data as streaming data to an external device, the first delimited sound data defining a delimited position between the first sound data and the second sound data.

18. The non-transitory computer-readable storage medium according to claim 17, wherein the first delimited sound data is arranged between the first sound data and the second sound data.

19. The non-transitory computer-readable storage medium according to claim 17, wherein transmitting the first sound data, the second sound data, and first delimited sound data as the streaming data to the external device comprises transmitting the first sound data and the second sound data with a first channel, and transmitting the first delimited sound data with a second channel different from the first channel.

20. A non-transitory computer-readable storage medium storing a program causing a computer to implement:
receiving streaming data including first sound data, second sound data, and delimited sound data defining a delimited position between the first sound data and the second sound data; and
extracting the first sound data and the second sound data, respectively, from the streaming data based on the delimited sound data.
